(19) United States
(12) Patent Application Publication
(10) Pub. No.: US 2014/0059438 A1
(43) Pub. Date: Feb. 27, 2014

(54) LECTURE SYSTEM

(71) Applicant: FU ZHI TECHNOLOGY CO., LTD., HSINCHU CITY (TW)

(72) Inventors: MING-YEN WU, HSINCHU CITY (TW); PING-FU CHEN, HSINCHU CITY (TW); WEN-CHUNG HU, HSINCHU CITY (TW)

(73) Assignee: FU ZHI TECHNOLOGY CO., LTD., HSINCHU CITY (TW)

(21) Appl. No.: 13/653,505

(22) Filed: Oct. 17, 2012

(30) Foreign Application Priority Data
Aug. 22, 2012 (TW) 101130365

(51) Int. Cl. G06F 3/048

(52) U.S. Cl. 715/730

(57) ABSTRACT

A lecture system is provided for the user to operate the teaching file on a display of an electronic device, the lecture system including a first sensor unit, a timer unit, a switch unit and a scroll unit. The first sensor unit is disposed corresponding to a first operating area; the timer unit electrically connects the first sensor unit and is installed with a threshold value; the switch unit electrically connects the timer unit and the first sensor unit for the user to switch between a first and a second input modes by operating on the first operating area for a first period of time less than the threshold value. The scroll unit electrically connects the timer unit and the first sensor unit for the user to scroll through the teaching file by operating on the first operating area for a second period of time longer than the threshold value.

This application claims the benefits of the Taiwan Patent Application Serial NO. 101130365 filed on Aug. 22, 2012, the subject matter of which is incorporated herein by reference.

### BACKGROUND OF THE INVENTION

1. Field of the Invention

The present invention relates to a lecture system, more particularly, relates to a lecture system in which two input modes are switched via operating areas and a teaching file is scrolled through in the two input modes.

2. Description of the Prior Art

The development of technology leads to the popularity of personal computers and thus the growth of the internet is dramatic; as a result, the internet becomes a very important part of people's ordinary lives. In the past, a person can mostly gain knowledge from books; at present, the internet is the greatest source of knowledge and information. Time has changed due to technology and the application technology and internet have been generally changing the teaching method.

Among present applications of teaching technologies, electronic whiteboards, especially interactive whiteboards, are the most commonly used. A computer's desktop is projected onto the surface of the electronic board; users can write on the board, the written texts can be printed out or displayed; even the process of writing can be recorded and saved as a video to be replayed.

Refer to FIG. 1, a schematic view of a conventional lecture system on an electronic device. According to FIG. 1, the conventional lecture system is utilized on an electronic device 1 having a display 11, on which a teaching file, a scroll 12, a cursor mode 21 and stylus mode 22 of a menu 2 are displayed. When a user has done with the stylus mode 22 and needs to scroll down, he/she has to select the cursor mode 21 of the menu 2 so as to switch and then scroll down. More particularly, a cursor 3 appears after the user selects and switches to the cursor mode 21 and with the cursor 3, the user scrolls up and down of the teaching file by the scroll 12.

When the electronic device 1 (e.g. electronic whiteboard) is in large size (between 37-inch to 100-inch, for example, 37-inch, 40-inch, 42-inch, 47-inch, 65-inch and 80-inch), the user has to spend more time reaching the menu 2 in order to switch to the cursor mode 21 and to scroll through the teaching file, which is very time consuming and the lecture is less efficient.

### SUMMARY OF THE INVENTION

In the prior art, since the user can only scroll through the teaching file under the cursor mode, if the user is in the stylus mode, he/she has to switch and select the cursor mode firstly in order to scroll. When an electronic whiteboard is in a large size, the user has to spend more time reaching and switching into the cursor mode, which is very time consuming and the lecture is less efficient.

A lecture system is provided according to the invention; more particularly, a lecture system in which two input modes are switched via operating areas and a teaching file is scrolled through in the two input modes is provided.

A lecture system is disposed in an electronic device for a user to operate on at least a teaching file via the electronic device, the teaching file being displayed on a display of the electronic device, the lecture system including a first sensor unit, a timer unit, a switch unit and a scroll unit. The first sensor unit is disposed corresponding to a first operating area, in the first operating area, the user switching between a first input mode and a second input mode and scrolling through the teaching file on the display. The timer unit electronically connects the first sensor unit and is installed with a threshold value. The switch unit electronically connects the first sensor unit and the timer unit, when the user operates on the first operating area within a first period of time less than the threshold value, the switch unit is for the user to switch between the first input mode and the second input mode. The scroll unit electronically connects the timer unit and the first sensor unit, when the user operates on the first operating area within a second period of time longer than the threshold value, the scroll unit is for the user to scroll through the teaching file.

Preferably, the lecture system further includes at least a second sensor unit, wherein the second sensor unit electrically connects the switch unit and the scroll unit and is disposed corresponding to a second operating area, in the second operating area, the user switching a menu into shown and hidden and scrolling through the teaching file; the first operating area is disposed at the bottom of the display and the second operating area is disposed on at least a side selected from the group of the right and the left side of the display. The teaching file is selected from the group of files of portable document format and files of flash. The threshold value is set to be 0.3 seconds or 0.5 seconds. The size of the display is selected from the group from 37-inch to 100-inch.

Preferably, the lecture system further includes a showing and hiding unit electrically connecting the second sensor unit and the switch unit for the user to switch between showing and hiding the menu in the second operating area. When the user operates on the second operating area, the second sensor unit generates and sends a second sensor signal to the showing and hiding unit so that the showing and hiding unit shows and hides the menu. Further, when the user operates on the first operating area to switch between the first input mode and the second input mode, the first sensor unit generates and sends a first sensor signal to the switch unit so that the switch unit switches between the first input mode and the second input mode. When the user operates on the first operating area to scroll through the teaching file, the first sensor unit generates and sends the first sensor signal to the scroll unit so that the scroll unit scrolls through the teaching file.

Furthermore, in the first operating area, the user further switches among the group selected from the first input mode, the second input mode, a third input mode and a fourth input mode. When the user operates on the first operating area within the first period of time less than the threshold value, the switch unit switches among the group selected from the first input mode, the second input mode, the third input mode and the fourth input mode. The first input mode includes a cursor mode, the second input mode includes a stylus mode, the third input mode includes a brush mode, and the fourth mode includes an eraser mode. The electronic device includes a stand touch-based electronic device and the display includes a large size display.

Compared with prior art, the lecture system provided according to the present invention includes two input modes being switched via operating areas and in the two input modes, the teaching file is scrolled through. That is, the user switches and scrolls via operating areas without wasting time on reaching the menu to switch into the cursor mode to scroll through the teaching file as it was conventionally.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a schematic view of a conventional lecture system on an electronic device;

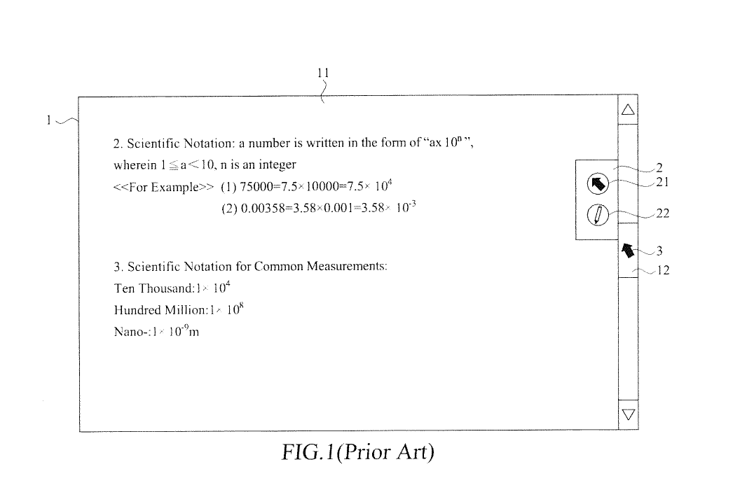

FIG. 2 is a block diagram showing a lecture system of an embodiment of the present invention; and

FIG. 3 is a schematic view of a lecture system of an embodiment of the present invention on an electronic device.

### DETAILED DESCRIPTION OF THE PREFERRED EMBODIMENT

The present invention relates to a lecture system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

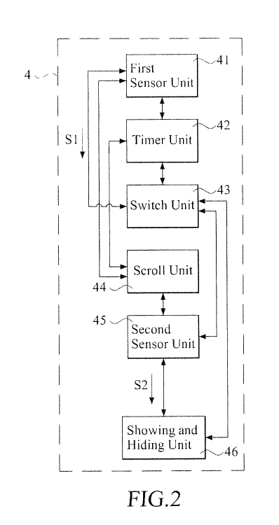

Refer to FIG. 2, a block diagram showing a lecture system of an embodiment of the present invention. A lecture system 4 is utilized on an electronic device (not shown) for a user to operate at least a teaching file via the electronic device and the teaching file is displayed on a display (not shown) of the electronic device. The teaching file is selected from the group of files of portable document format (PDF), files of flash and files written in other program languages. According to an the embodiment of the present invention, the teaching file includes a PDF file; the electronic device includes a stand touch-based electronic device and the display includes a large size display, the size of which is between 37-inch to 100-inch, for example, 37-inch, 40-inch, 42-inch, 47-inch, 65-inch and 80-inch.

The lecture system 4 includes a first sensor unit 41, a timer unit 42, a switch unit 43, a scroll unit 44, a second sensor unit 45 and a showing and hiding unit 46. The first sensor unit 41 is disposed corresponding to a first operating area (not shown); the timer unit 42 electrically connects the first sensor unit 41 and is installed with a threshold value; the switch unit 43 electrically connects the first sensor unit and the timer unit 42; the scroll unit 44 electrically connects the first sensor unit and the timer unit 42; the second sensor unit 45 electrically connects the switch unit 43 and the scroll unit 44; the showing and hiding unit 46 electrically connects the switch unit 43 and the second unit 45 and is disposed corresponding to a second operating area (not shown).

The first operating area corresponding to the first sensor unit 41 is for the user to switch among a first input mode, a second input mode, a third input mode and a fourth input mode and to scroll through the teaching file. The first input mode includes a cursor mode; the second input mode includes a stylus mode; the third input mode includes a brush mode; and the fourth mode includes an eraser mode.

When the user operates on the first operating area for a first period of time less than the threshold value, the switch unit 43 is for the user to switch among the first input mode, the second input mode, the third input mode and the fourth input mode. When the user operates on the first operating area for a second period of time longer than the threshold value under the first, second, third or fourth mode, the scroll unit 44 is for the user to scroll through the teaching file.

When the user operates on the first operating area for the first period of time less than the threshold value, the first sensor unit 41 generates and sends a first sensor signal S1 to the switch unit 43 so that the switch unit 43 switches among the first, second, third or fourth mode. When the user operates on the first operating area with the second period of time longer than the threshold, the first sensor unit 41 generates and sends the first sensor signal S1 to the scroll unit 44 so that the scroll unit 44 scrolls through the teaching file.

The second sensor unit 45 is disposed corresponding to the second operating area and in the second operating area, the user switches a menu into shown and hidden and scrolls through the teaching file. The showing and hiding unit 46 is for the user to switch between showing and hiding the menu in the second operating area; when the user operates on the second operating area, the second sensor unit 45 generates and sends a second sensor signal S2 to the showing and hiding unit 46 so that the showing and hiding unit 46 shows and hides the menu accordingly.

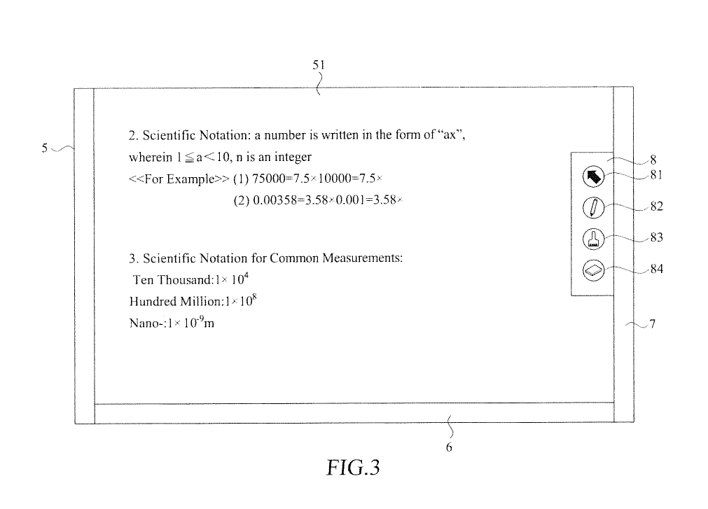

Refer to FIG. 2 and FIG. 3. FIG. 3 is a schematic view of a lecture system of an embodiment of the present invention on an electronic device. The lectures system 4 is utilized on a stand touch-based electronic device 5; a display 51 of the stand touch-based electronic device 5 displays the teaching file, a first operating area 6, two second operating areas 7 (only one second operating area 7 is indicated) and a menu 8.

The first operating area 6 is disposed at the bottom of the display 51 and is installed with the first sensor unit 41 correspondingly; the second operating area 7 is disposed on the right and the left side of the display 51 and is installed with the second sensor unit 44. The menu 8 includes a first input mode, a second input mode, a third input mode and a fourth input mode, wherein the first input mode includes a cursor mode 81, the second input mode includes a stylus mode 82, the third input mode includes a brush mode 83, and the fourth mode includes an eraser mode 84. Furthermore, according to the embodiment of the present invention, the first operating area 6 covers the whole bottom of the display 51 in a strip shape, instead of just a part of the bottom of the display 51; the two second operating areas 7 cover the whole left and right side of the display 51 in strips, instead of just parts of the left and right side of the display 51—so the user switches and scrolls through the teaching file flexibly. Moreover, the display 51 supports the user to touch and write down texts.

When the user is to scroll through the teaching file, the user operates on the first operating area 6 (more particularly, the user touches the display 51 on the first operating area 6) for the second period of time longer than the threshold value, the scroll unit 44 scrolls through the teaching file and the threshold value includes 0.3 seconds or 0.5 seconds and is not limited thereof. According to other embodiment of the present invention, when the electronic device includes a computer, the user clicks on the first operating area 6 with cursors (not shown) corresponding to the four input modes so as to scroll through the teaching file. More particularly, when the user operates on the first operating area 6 for the second period of time longer than the threshold value, the first sensor unit 41 generates and sends the first sensor signal S1 to the scroll unit 44 so that the scroll unit 44 scrolls through the teaching file.

When the user is to switch among input modes, the user operates on the first operating area 6 (more particularly, the user touches the display 51 on the first operating area 6) for the first period of time less than the threshold value, the switch unit 43 switches among the cursor mode 81, the stylus mode 82, the brush mode 83 and the eraser mode 84; the threshold value includes 0.3 seconds or 0.5 seconds and is not limited thereof. In other words, the user operates on the first operating area 6 for the first period of time less than the threshold value to switch among four input modes. More particularly, when the user operates on the first operating area 6 for the first period of time less than the threshold value, the first sensor unit 41 generates and send the first sensor signal S1 to the switch unit 43 so that the switch unit 43 switches among the input modes.

When the user is to scroll through the teaching file, the user can alternatively operate on the two operating areas 7 (more particularly, the user touches the display 51 on the second operating area 7) by touch, hold and then scroll so that the scroll unit 44 scrolls through the teaching file. That is, when the user operates on the second operating areas 7, the second sensor unit 45 generates and sends the second sensor signal S2 to the scroll unit 44 so that the scroll unit 44 scrolls through the teaching file.

When the user is to show and hide the menu 8, the user can alternatively operate on the two operating areas 7 (more particularly, the user touches the display 51 on the second operating area 7), the second sensor unit 45 generates and sends the second sensor signal S2 to the showing and hiding unit 46 so that the showing and hiding unit 46 shows and hides the menu 8.

More particularly, according to the embodiment of the present invention, the menu 8 is on the right side of the display 51 and when the user clicks on the second operating area 7 on the right side of the display 51, the showing and hiding unit 46 hides the menu 8; when the user clicks on the second operating area 7 on the right side of the display 51 again, the showing and hiding unit 46 shows the menu 8. When the user clicks on the second operating area 7 on the left side of the display 51, the showing and hiding unit 46 hides the menu 8 on the right side of the display 51 and shows the menu 8 on the left side of the display 51. As a result, the user saves time from reaching the menu 8, which is more efficient and improves the quality of lecture.

In conclusion, the lecture system 4 according to embodiments of the present invention switches among four input modes via the first operating area 6 and scrolls through the teaching file in four input modes. Thus, the user operates on the first operating area 6 for switching and scrolling, which is time-saving and thus the quality of lecture is improved.

While the present invention has been particularly shown and described with reference to a preferred embodiment, it will be understood by those skilled in the art that various changes in form and detail may be without departing from the spirit and scope of the present invention.

What is claimed is:

1. A lecture system disposed in an electronic device for a user to operate on at least a teaching file, the teaching file being displayed on a display of the electronic device, the lecture system comprising:
a first sensor unit, disposed corresponding to a first operating area, in the first operating area, the user switching between a first input mode and a second input mode and scrolling through the teaching file on the display;
a timer unit, electronically connecting the first sensor unit and being installed with a threshold value;
a switch unit, electronically connecting the first sensor unit and the timer unit, when the user operates on the first operating area within a first period of time less than the threshold value, the switch unit is for the user to switch between the first input mode and the second input mode; and
a scroll unit, electronically connecting the timer unit and the first sensor unit, when the user operates on the first operating area within a second period of time longer than the threshold value, the scroll unit is for the user to scroll through the teaching file.

2. The lecture system according to claim 1, wherein the teaching file is selected from the group of files of portable document format and files of flash.

3. The lecture system according to claim 1, wherein when the user operates on the first operating area with the first period of time less than the threshold, the first sensor unit generates and sends a first sensor signal to the switch unit so that the switch unit switches between the first input mode and the second input mode.

4. The lecture system according to claim 3, wherein when the user operates on the first operating area with the second period of time longer than the threshold, the first sensor unit generates and sends the first sensor signal to the scroll unit so that the scroll unit scrolls through the teaching file.

5. The lecture system according to claim 1, further comprising at least a second sensor unit, wherein the second sensor unit electrically connects the switch unit and the scroll unit and is disposed corresponding to a second operating area, in the second operating area, the user switching a menu into shown and hidden and scrolling through the teaching file.

6. The lecture system according to claim 5, wherein the first operating area is disposed at the bottom of the display and the second operating area is disposed on at least a side selected from the group of the right and the left side of the display.

7. The lecture system according to claim 5, further comprising a showing and hiding unit electrically connecting the second sensor unit and the switch unit for the user to switch between showing and hiding the menu in the second operating area.

8. The lecture system according to claim 7, wherein when the user operates on the second operating area, the second sensor unit generates and sends a second sensor signal to the showing and hiding unit so that the showing and hiding unit shows and hides the menu.

9. The lecture system according to claim 1, wherein in the first operating area, the user further switches among the group selected from the first input mode, the second input mode, a third input mode and a fourth input mode, when the user operates on the first operating area within the first period of time less than the threshold value, the switch unit switches among the group selected from the first input mode, the second input mode, the third input mode and the fourth input mode.

10. The lecture system according to claim 9, wherein the first input mode includes a cursor mode, the second input mode includes a stylus mode, the third input mode includes a brush mode, and the fourth mode includes an eraser mode.

11. The lecture system according to claim 1, wherein the electronic device includes a stand touch-based electronic device and the display includes a large size display.

12. The lecture system according to claim 1, wherein the threshold value is selected from the group of 0.3 seconds and 0.5 seconds.

13. The lecture system according to claim 1, wherein the size of the display is selected from the group of 37-inch to 100-inch.
